(19) United States
(12) Patent Application Publication
(10) Pub. No.: US 2026/0228014 A1
(43) Pub. Date: Aug. 6, 2026

(54) READ-ONLY MEMORY BANK FOR STORING BOOTUP CODE

(71) Applicant: Micron Technology, Inc., Boise, ID (US)

(72) Inventor: Rainer Bonitz, Bruckmühl (DE)

(21) Appl. No.: 19/444,996

(22) Filed: Jan. 9, 2026

Related U.S. Application Data
(60) Provisional application No. 63/752,506, filed on Jan. 31, 2025.

(51) Int. Cl. G06F 9/4401; G06F 3/06

(52) U.S. Cl. CPC G06F 9/4401; G06F 3/0604; G06F 3/0655; G06F 3/0673

(57) ABSTRACT

Methods, systems, and devices for a read-only memory (ROM) bank for storing bootup code are described. A dynamic random-access memory (DRAM) device may implement at least a portion of non-volatile memory within the DRAM device for storing bootup code and/or program code. Accordingly, a host system may, upon powering on the DRAM device, directly access the bootup code and/or program code from the portion of non-volatile memory in the DRAM device. In some examples, the portion of non-volatile memory may be a mask programmable bank from a set of banks or be an electrical programmable bank. Additionally, the portion of the non-volatile memory in the DRAM device may be implemented in under-array circuitry separate from a DRAM memory array, in a separate extra array beside the DRAM array, or in a separate die electrically coupled with the DRAM memory through silicon vias or other interconnects.

### CROSS REFERENCE

The present Application for Patent claims priority to U.S. Patent Application No. 63/752,506 by Bonitz, entitled “READ-ONLY MEMORY BANK FOR STORING BOOTUP CODE,” filed January 31, 2025, which is assigned to the assignee hereof, and which is expressly incorporated by reference in its entirety herein.

### TECHNICAL FIELD

The following relates to one or more systems for memory, including a read-only memory (ROM) bank for storing bootup code.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports a read-only memory (ROM) bank for storing bootup code in accordance with examples as disclosed herein.

FIG. 2 shows an example of a system that supports a ROM bank for storing bootup code in accordance with examples as disclosed herein.

FIG. 3 shows an example of an architecture that supports a ROM bank for storing bootup code in accordance with examples as disclosed herein.

FIG. 4 shows an example of a process flow that supports a ROM bank for storing bootup code in accordance with examples as disclosed herein.

FIG. 5 shows a block diagram of a memory system that supports a ROM bank for storing bootup code in accordance with examples as disclosed herein.

FIG. 6 shows a flowchart illustrating a method or methods that support ROM bank for storing bootup code in accordance with examples as disclosed herein.

### DETAILED DESCRIPTION

In some memory systems (e.g., systems implementing dynamic random-access memory (DRAM)), instructions for booting up the memory system (e.g., bootup code) may be stored in an external non-volatile memory device for persistent storage. The non-volatile memory device may also store program code for program execution by a host system (e.g., central processing unit (CPU)) as well as data for program cache filling. In some cases, as part of a power-on procedure, the bootup code and/or the program code may be transferred from the external non-volatile memory device to the DRAM. Subsequently, the host system may load the bootup code and/or program code from the DRAM into its program cache, at which point the host system may begin initiating program execution. However, loading the bootup code and/or program code from the external non-volatile memory device into the DRAM may result in an excessively long bootup time for the memory system, which in some cases may negatively impact the efficiency or effectiveness of executable programs.

In accordance with examples described herein, a DRAM device may implement at least a portion of non-volatile memory (e.g., read-only memory (ROM)) within the DRAM device for storing bootup code and/or program code. Accordingly, a host system may, upon powering on the DRAM device, directly access the bootup code and/or program code from the portion of non-volatile memory in the DRAM device, eliminating excess time spent loading code from an external non-volatile memory device, and thereby improving bootup efficiency. In some examples, the portion of the DRAM device that includes the non-volatile memory may be a mask programmable bank from a set of banks, where the mask programmable bank is configured to store non-erasable and permanent information (e.g., code and data). In some other examples, the portion of the DRAM device that includes the non-volatile memory may be an electrical programmable bank, if the data retention time of such a bank is sufficient for the target application associated with the DRAM device. Additionally, the portion of the non-volatile memory in the DRAM device may be implemented in under-array circuitry separate from a DRAM memory array, in a separate extra array beside the DRAM array, or in a separate die (e.g., ROM die or a programmable die) electrically coupled with the DRAM memory through silicon vias or other interconnects. In such examples, the electrical coupling between DRAM banks and the portion of the non-volatile memory of the DRAM device (e.g., one or more ROM banks) may involve both an interconnect solution and an additional electrical coupling circuit inside of the DRAM device.

In addition to applicability in memory systems as described herein, techniques for a ROM bank for storing bootup code may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds and system bootup speeds, which may decrease processing or latency times, improve response times, or otherwise improve user experience, among other benefits.

Features of the disclosure are illustrated and described in the context of systems. Features of the disclosure are further illustrated and described in the context of architectures, process flows, block diagrams, and flowcharts.

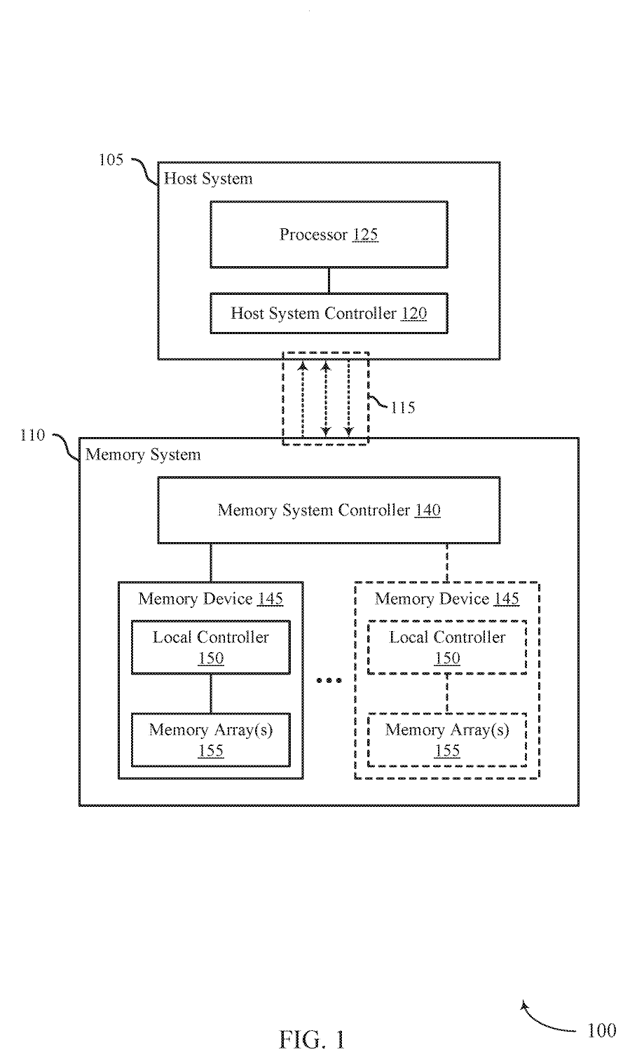

FIG. 1 shows an example of a system 100 that supports a ROM bank for storing bootup code in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a CPU, a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

In some memory systems 110, instructions for booting up the memory system 110 (e.g., bootup code) may be stored in an external non-volatile memory device for persistent storage. The non-volatile memory device may also store program code for program execution by a host system 105 (e.g., CPU) as well as data for program cache filling. In some cases, the bootup code and/or the program code is transferred from the external non-volatile memory device to one or more memory arrays 155 after the memory system is powered on. Subsequently, the host system 105 may load the bootup code and/or program code from the memory arrays 155 into its program cache, at which point the host system 105 may begin initiating program execution. However, loading the bootup code and/or program code from the external non-volatile memory device into the memory arrays 155 may result in an excessively long bootup time for the memory system 110, which in some cases may negatively impact the efficiency or effectiveness of some programs.

In accordance with examples described herein, a memory device 145 may implement at least a portion of non-volatile memory (e.g., ROM) within the memory device 145 for storing bootup code and/or program code. Accordingly, a host system 105 may, upon powering on the memory system 110, directly access the bootup code and/or program code from the portion of non-volatile memory in the memory device 145, eliminating excess time spent loading code from an external non-volatile memory device, and thereby improving bootup efficiency. In some examples, the portion of the memory device 145 that includes the non-volatile memory may be a mask programmable bank from a set of banks, where the mask programmable bank is configured to store non-erasable and permanent information (e.g., code and data). In some other examples, the portion of the memory device 145 that includes the non-volatile memory may be an electrical programmable bank, if the data retention time of such a bank is sufficient for the target application associated with the memory device 145. Additionally, the portion of the non-volatile memory in the memory device 145 may be implemented in under-array circuitry separate from a memory array 155, in a separate extra array beside the memory array 155, or in a separate die (e.g., ROM die or a programmable die) electrically coupled with the memory device 145 through silicon vias or other interconnects. In such examples, the electrical coupling between DRAM banks and the portion of the non-volatile memory of the memory device 145 (e.g., one or more ROM banks) may involve both an interconnect solution and an additional electrical coupling circuit inside of the memory device 145.

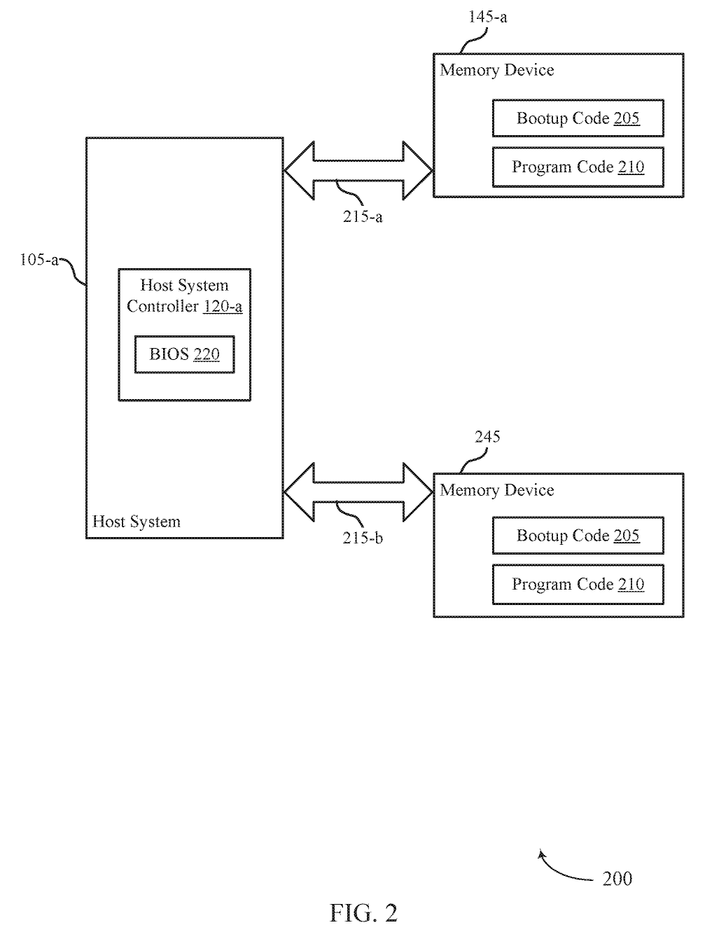

FIG. 2 shows an example of a system 200 that supports a ROM bank for storing bootup code in accordance with examples as disclosed herein. The system 200 may implement, or may be implemented by, aspects of the system 100. For example, the system 200 may include a host system 105-a, a host system controller 120-a, and a memory device 145-a (e.g., a DRAM device storing volatile memory, double data rate (DDR) device, a low power DDR (LPDDR) device, a graphics DDR (GDDR) device, a high memory bandwidth (HBM) device, among other examples), which may be examples of corresponding devices or components described herein.

In the system 200, a memory device 245 may store bootup code 205 (e.g., instructions to obtain program code 210, instructions to initialize devices, among other examples) and program code 210 (e.g., an operating system, code for an operation system, user software, application software, among other examples), where the bootup code 205 and program code 210 may be utilized by the host system 105-a. In such examples, the memory device 245 may be a non-volatile memory device, such as a not OR (NOR) memory device, an electrically erasable programmable ROM (EEPROM) memory device, a not-AND (NAND) memory device, an embedded multi-media card (eMMC) memory device, a universal flash storage (UFS) device, a solid-state drive (SSD), among other examples.

On power up of the system 200, the host system 105-a may perform a link set up procedure (e.g., device initialization procedure) to configure the links 215 between the memory device 145-a and the memory device 245. Accordingly, in response to competition of the link set up procedure, the bootup code 205 may be transferred from the memory device 245 to the memory device 145-a. For example, the host system controller 120-a may execute basic input/output system (BIOS) code 220 to download the bootup code 205 from the memory device 245 to the memory device 145-a (e.g., via the interfaces 215-a and 215-b). In response to downloading the bootup code 205, the host system controller 120-a may execute various commands from the bootup code 205 to download the program code 210 (e.g., a complete or partial download) from the memory device 245 to the memory device 145-a via the respective links 215.

In some other examples, in response to the link set up procedure, the host system controller 120-a may execute the BIOS code 220 to download the bootup code 205 and a portion of the program code 210 to the memory device 145-a, where, in response, the host system controller 120-a may execute various commands of the bootup code 205 to download the remaining portion of the program code 210 to the memory device 145-a. In some examples, in response to the link set up procedure, the host system controller 120-a may download the bootup code 205 or the complete program code 210 to the memory device 145-a.

However, during such bootup sequences, the system 200 may suffer from various time delays as a result of the bootup code 205 and/or program code 210 being stored in the non-volatile memory device 245. For example, establishing the interface 215-b (e.g., link) between the non-volatile memory device 245 and the host system 105-a may be carried out over a duration, which may be defined by a link setup time. Additionally, the memory device 245 may take time to initialize, which may be defined as an initialization time. Moreover, download of the bootup code 205 and/or program code 210 from the memory device 245 to the memory device 145-a via the interface 215-b and the interface 215-a may be associated with relatively significant time delays. Such time delays may be increased in cases where both the bootup code 205 and the program code 210 is being downloaded to the memory device 145-a. These and other potential time delays associated with operation of and/or communication with the memory device 245 may result in inefficiencies and relatively slow bootup times for the system 200.

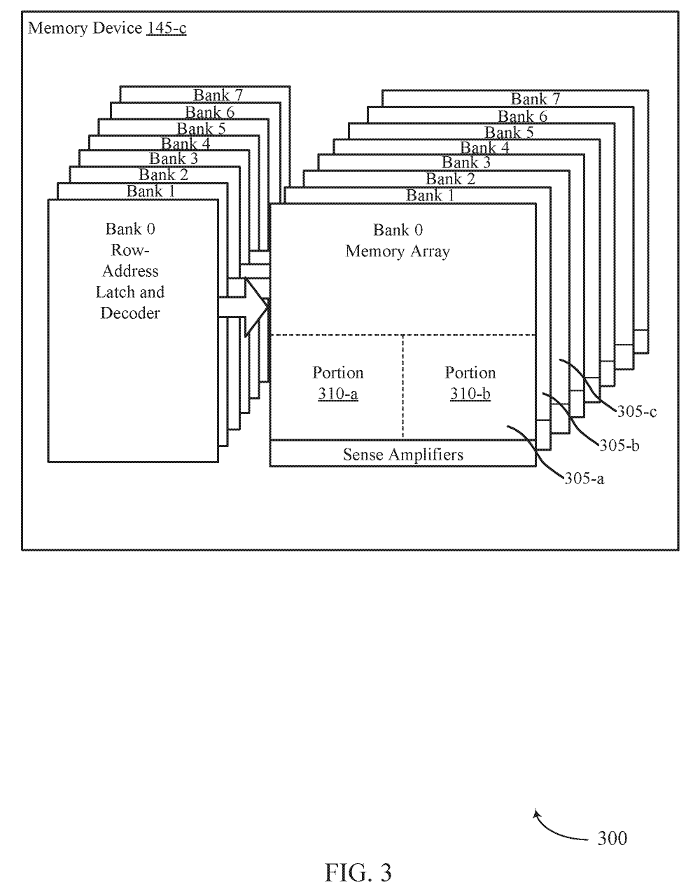

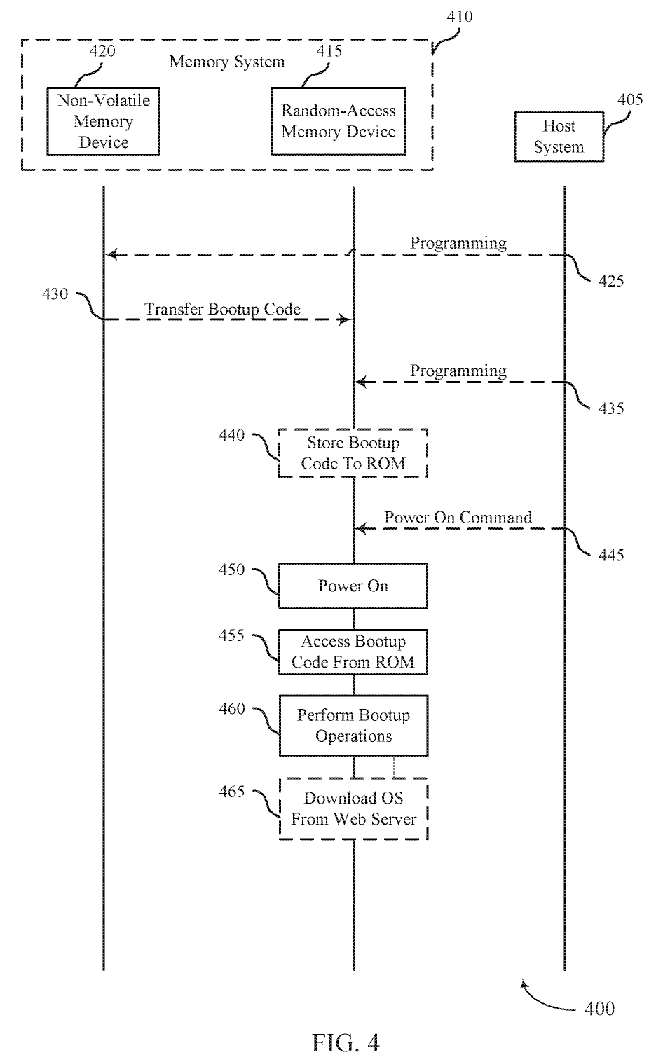

In accordance with examples described herein, the memory device 145-a may include at least a portion of non-volatile memory for storing the bootup code 205 and/or the program code 210, which may eliminate time delays associated with loading from the memory device 245, thereby improving system efficiency and response times. In some cases, the memory device 245 may be removed from the system 200 entirely and execution of the bootup code 205 for performing bootup functions may be based on the host system 105-a reading the bootup code 205 from the non-volatile memory stored within the memory device 145-a. Alternatively, the non-volatile memory device 245 may be used by the host system 105-a (e.g., via the interface 215-b) during initial programming of the memory device 145-a to store the bootup code 205 and/or program code 210 to the memory device 145-a, and the bootup code 205 and the program code 210 may persist in ROM (e.g., and be communicated via the interface 215-a) thereafter. Implementations for mechanisms of storing non-volatile memory within the memory device 145-a as well as programming of bootup code 205 and/or program code 210 into the non-volatile memory of the memory device 145-a will be described in greater detail with reference to FIGS. 3 and 4.

FIG. 3 shows an example of an architecture 300 that supports a ROM bank for storing bootup code in accordance with examples as disclosed herein. The architecture 300 may implement or may be implemented by aspects of the system 100 or the system 200. For example, the architecture 300 may include a memory device 145-c which may be an example of a memory device 145 as described herein. Moreover, the architecture 300 may include a bank 305-a, a 305-b, and a 305-c, as well as other banks 305, which may be examples of banks included in a memory array 155 as described herein.

In accordance with examples described herein, the memory device 145-c may be a volatile memory device and may include at least a portion of non-volatile memory and a portion of volatile memory. For example, the portion of non-volatile memory within the DRAM memory device 145-c may be a first portion 310-a of a bank 305-a, may be an entire bank 305-a, may be multiple banks 305 (e.g., a bank 305-a and a bank 305-b), or any combination thereof. In some examples, a first portion 310-a may include non-volatile memory while a second portion 310-b includes DRAM (e.g., volatile memory). The first portion 310-a may correspond to a first subset of rows of the bank 305-a, a first subset of columns of the bank 305-a, or both. The second portion 310-b may correspond to a second subset of rows of the bank 305-a, a second subset of columns of the bank 305-a, or both. In some examples, a first bank 305-a or set of banks 305 may include non-volatile memory while a second bank 305-b or set of banks 305 may include DRAM (e.g., volatile memory). In some examples, the portion of non-volatile memory may correspond to an address range of the memory device 145-c that is configured to store the non-volatile memory (e.g., a first bank address range, a last bank address range).

In some examples, the DRAM layout may be physically modified to enable at least one bank 305-a (e.g., bank 0) within a set of DRAM banks (e.g., banks 0 through 7) to store non-volatile memory (e.g., ROM). In such examples, one or more DRAM banks 305 may be replaced by one or more ROM banks 305, or the ROM banks 305 may be added as extra banks in addition to the existing DRAM banks 305.

In some examples, one bank 305 from a set of banks 305 within the DRAM memory device 145-c may be implemented as a ROM bank 305 using a dedicated mask (e.g., contact, metal). For example, the portion of the memory device 145-c that includes the non-volatile memory may be a mask programmable bank 305 from the set of banks 305, where the mask programmable bank 305 is configured to store non-erasable and permanent information (e.g., code and data). In some other examples, the portion of the memory device 145-c that includes the non-volatile memory may be an electrical programmable bank, if the data retention time of such a bank 305 is sufficient for the target application associated with the memory device 145-c. For example, a permanent memory bit status may be applied to a set of transistors of the memory device 145-c using a lithography mask based programming procedure or laser lithography programming based procedure, where the permanent memory bit status forms the portion of non-volatile memory in the memory device 145-c.

In some examples, a set of transistors included in (e.g., or implemented by) the ROM bank 305 may be of a first transistor type that is electrically programmable. Such transistors may be electrically programmed based on completion of device production (e.g., as part of a post-production process) or else by a customer (e.g., signaling from a host system). Additionally, or alternatively, the transistors of the ROM bank 305 may be a second transistor type that is mask programmable. Such transistors may be mask programmed during device production. The at least one ROM bank 305 and the DRAM banks 305 (e.g., a remainder of DRAM banks 305 not replaced by ROM banks) may be located in a same die of the memory device 145-c.

In some examples, the portion of non-volatile memory may be implemented in circuitry underneath a DRAM array of the memory device 145-c. For example, a first bank 305 that includes the non-volatile memory may be included in circuitry positioned separate from and under one or more second banks 305 that includes the volatile memory (e.g., in an array of memory cells). In some examples, the non-volatile memory may be included in a second memory array (e.g., an extra array) different and separate from the DRAM array.

In some examples, the portion of the non-volatile memory may be implemented in an additional ROM die that is connected to a DRAM die by bonding or through silicon vias to the DRAM internal memory address and data space. For example, a first die of the memory device 145-c may include the volatile memory (e.g., DRAM memory array) and a second die of the memory device 145-c may include the non-volatile memory and may be coupled with the first die through one or more vias (e.g., silicon vias). In some examples, the first and second dies may be included in different interconnected chiplets within the memory device 145-c and may be implemented in accordance with a wafer-to-wafer technology or chiplet connectivity technology.

In some examples, the portion of the non-volatile memory within the DRAM memory device 145-c may store bootup code, and the bootup code may include instructions, among other examples) to download program code (e.g., an operating system) from an external web server or any other network attached device (e.g., instructions that point to a web server, a web page, a uniform resource locator (URL), among other examples for download of the program code). That is, a controller (e.g., processing circuitry) coupled with the memory device 145-c may execute the bootup code to obtain the program code (e.g., the operating system) via a network connected device, which may be coupled with the controller and the memory device 145-c. By downloading the program code from the network connected device, the controller of the memory device 145-c may ensure that the program code (e.g., operating system) is continuously up to date at bootup time and that the system implementing the memory device 145-c (e.g., the systems, as illustrated and described herein with reference to FIGS. 1 and 2) may function without a mass storage device, such as a non-volatile memory device (e.g., eMMC, UFS, SSD, NAND, among other examples). By refraining from implementing non-volatile memory device, the cost of the system implementing the memory device 145-c may benefit from cost savings, energy savings, and space on the printed circuit boards implementing the system.

In some other examples, a size (e.g., capacity) of the non-volatile memory may be sufficiently large (e.g., satisfies a threshold), and the non-volatile memory may store the entire program code with or without the bootup code. The program code to be downloaded from the external web server or any other network attached device or stored in the non-volatile memory itself may include stored data or parameters from a last application power cycle of the memory device 145-c.

Thus, in accordance with these and other examples, the memory device 145-c may store the bootup code and/or program code directly within its own non-volatile memory (e.g., as opposed to pulling the code from an external non-volatile memory device at each power cycle). Immediately after the power on time of both the memory device 145-c and a host system, the memory device 145-c may make use of the code stored in the ROM (e.g., by initializing bootup operations indicated by the code). Accordingly, the memory device 145-c may experience a startup acceleration advantage relative to other memory architectures, and boot up times for the memory device 145-c may be significantly reduced (e.g., by 100-200 milliseconds). Such time savings may be particularly advantageous in systems which implement medical applications (e.g., which may be sensitive to power savings), systems in which a download of the latest operating system from a web server or any other network attached device occurs during initialization, systems associated with an ultra-fast system boot threshold, or high volume cost sensitive applications, among other examples.

FIG. 4 shows an example of a process flow 400 that supports a ROM bank for storing bootup code in accordance with examples as disclosed herein. The process flow 400 may implement or may be implemented by aspects of the system 100 or the system 200. For example, the process flow 400 may include a memory system 410 and a host system 405, which may be examples of a memory system 110 and a host system 105, respectively, as described herein.

At 425, in some examples, the host system 405 may program (e.g., store as part of a programming procedure) bootup code and/or program code to a non-volatile memory device 420 of the memory system 410. If the procedures at 425 occurred, at 430 (e.g., as part of the programming procedure or a different programming procedure), the non-volatile memory device 420 may transfer the bootup code and/or program code to the random-access memory device 415, where the bootup code and/or program code may be stored to a portion of the random-access memory device 415. In some examples, the location of the random-access memory device 415 where the bootup code and/or program code is stored may include non-volatile memory (e.g., ROM).

In some other examples, at 435, the host system 405 may program bootup code and/or program code directly to the random-access memory device 415. Such procedures may be part of a production process or be performed prior to implementation of the random-access memory device 415 within the system as a whole. At 440, the random-access memory device 415 may store the bootup code and/or program code into ROM (e.g., a ROM bank, a ROM die, as described with reference to FIG. 4). The random-access memory device 415 may store the bootup code and/or program code into the ROM in response to completion of a programming procedure (e.g., production process) at the memory system 410.

At 445, the random-access memory device 415 may receive a power on command from the host system 405. At 450, the random-access memory device 415 may power on in response to receiving the power on command (e.g., and may execute a device initialization procedure, execute link initialization, among other examples). At 455, in response to (e.g., in direct response to) the random-access memory device 415 powering on (e.g., and the device initialization), the random-access memory device 415 may access bootup code and/or program code associated with a bootup procedure of the memory system 410. For example, the random-access memory device 415 may access the bootup code and/or program code directly from ROM which is stored internally to the random-access memory device 415. In some examples, the bootup code may be stored at a first address corresponding to a starting index of a first bank (e.g., Bank 0) of the random-access memory device 415, and the random-access memory device 415 may access the bootup code by reading the first address corresponding to the starting index. The first address of the first bank may include ROM. In some examples, the program code may be stored in a consecutive address range after the bootup code.

At 460, the random-access memory device 415 may perform one or more operations as part of the bootup procedure of the memory system 410. In some cases, the code stored within the ROM of the random-access memory device 415 may include an entire program code for the memory system 410, and the memory system 410 may initiate program execution based on the program code stored in the ROM. In some other cases, at 465, the random-access memory device 415 may download program code from a server (e.g., web server) or any other network attached device based on instructions in the bootup code. The program code may include an operating system for the random-access memory device, an application software for the random-access memory device, or both.

In some examples, during operation of the random-access memory device 415, the random-access memory device 415 may be enabled for access to both integrated DRAM banks and ROM banks. For example, a single operating mode of the random-access memory device 415 may enable such access to both types of banks. In some implementations, access to the DRAM banks may be according to a first set of frequency set point parameters (e.g., Frequency Set Point 2) and access to the ROM banks may be according to a second set of frequency set point parameters (e.g., Frequency Set Point 1). Additionally, or alternatively, access to the DRAM banks may be based on a first subset of DRAM commands from the host system 405 and access to the ROM banks may be based on a second subset of DRAM commands from the host system 405.

Usage of different frequency set points within the random-access memory device 415 may allow the random-access memory device 415 to switch operating (e.g., access) frequencies fluently from one operating frequency to another one and back. The controller of the memory system 410 may access the non-volatile portion of the random-access memory device 415 at a different (e.g., likely slower) frequency, than the frequency used to access the volatile (e.g., DRAM) portions of the random-access memory device 415.

For example, frequency set points may allow a bus between the memory system 410 and the random-access memory device 415 (e.g., or a command and address (CA) bus between the host system 405 and the random-access memory device) to be switched between three different operating frequencies, with changes in voltage swings and termination values, without being in an untrained state (e.g., which could result in a loss of communication to the memory system 110). To do so, CA bus mode register parameters may be duplicated, as well as other mode register parameters commonly changed with operating frequency. These tripled registers form three sets that use the same mode register addresses, with read and write access controlled by a frequency set point write/read bit of the mode register (e.g., MR bit FSP-WR) and the device (e.g., the random-access memory device 415) operating point controlled by a frequency set point operation bit (e.g., MR bit FSP-OP). Accordingly, changing the FSP-WR bit enables the mode register parameters to be changed for a selected frequency set point without affecting the device’s (e.g., the random-access memory device 415) current operation. Based on the parameters being written to the selected set point, changing the FSP-OP bit will switch operation to use the newly selected parameters simultaneously (within a threshold time (tFC)), eliminating the possibility of a loss of communication that could be caused by a partial configuration change.

Thus, in accordance with the process flow 400, the memory system 410 may support increased bootup speeds by allowing for access of the bootup code from ROM immediately after power on of the random-access memory device 415. For example, instead of fetching the bootup code from a separate non-volatile memory device during bootup, which may be excessively slow, the random-access memory device 415 may store the bootup code into dedicated ROM during programming procedures prior to power on, and the memory system 410 may benefit from time savings associated with direct read access of the bootup code from the random-access memory device 415, thereby increasing system efficiency during bootup of the memory system 410.

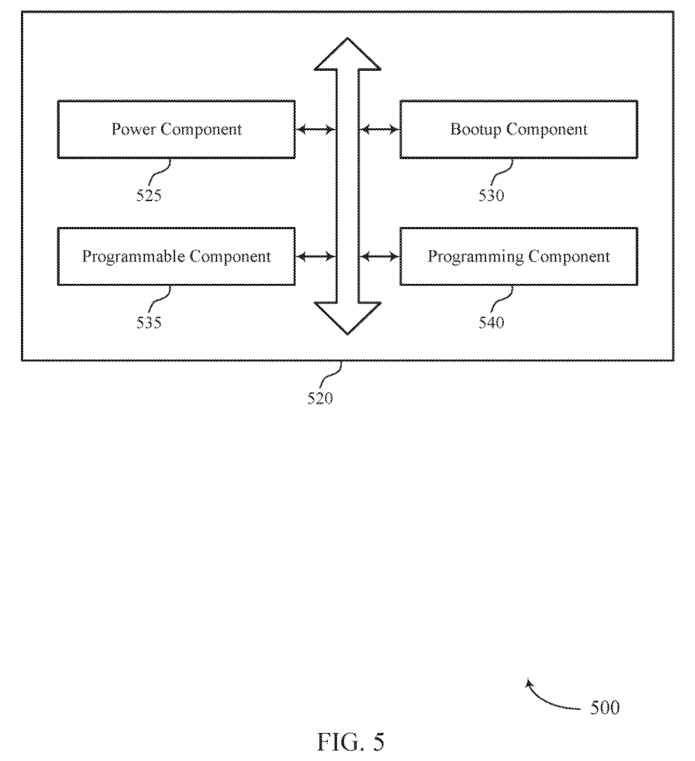

FIG. 5 shows a block diagram 500 of a memory system 520 that supports a ROM bank for storing bootup code in accordance with examples as disclosed herein. The memory system 520 may be an example of aspects of a memory system as described with reference to FIGS. 1 through 4. The memory system 520, or various components thereof, may be an example of means for performing various aspects of a ROM bank for storing bootup code as described herein. For example, the memory system 520 may include a power component 525, a bootup component 530, a programmable component 535, a programming component 540, or any combination thereof. Each of these components, or components of subcomponents thereof (e.g., one or more processors, one or more memories), may communicate, directly or indirectly, with one another (e.g., via one or more buses).

The memory system 520 may support operating a memory system in accordance with examples as disclosed herein. The power component 525 may be configured as or otherwise support a means for powering on the memory system. The bootup component 530 may be configured as or otherwise support a means for accessing, based at least in part on powering on the memory system, bootup code associated with a bootup procedure of the memory system from a random-access memory device, where the random-access memory device includes a first portion of non-volatile memory and a second portion of volatile memory, and where the bootup code is stored in the first portion of non-volatile memory. In some examples, the bootup component 530 may be configured as or otherwise support a means for performing one or more operations associated with the bootup procedure based at least in part on accessing the bootup code from the first portion of non-volatile memory.

In some examples, the programmable component 535 may be configured to support a means for applying a permanent memory bit status to a set of transistors of the random-access memory device in accordance with a lithography mask based programming procedure or laser lithography programming based procedure or electrical programming procedure, where the permanent memory bit status forms the first portion of non-volatile memory in the random-access memory device, and where the bootup code is stored in the first portion of non-volatile memory according to applying the lithography mask based programming procedure or the laser lithography programming based procedure.

In some examples, the programming component 540 may be configured as or otherwise support a means for writing the bootup code to the first portion of non-volatile memory in response to completion of a programming procedure at the memory system.

In some examples, to support performing the one or more operations associated with the bootup procedure, the bootup component 530 may be configured as or otherwise support a means for downloading, from a web server or any other network attached device based at least in part on the bootup code, program code associated with an operating system of the memory system.

In some examples, the first portion of the non-volatile memory includes one or more banks of the random-access memory device.

In some examples, the first portion of non-volatile memory includes a first bank and the second portion of volatile memory includes one or more second banks. In some examples, the first bank is included in circuitry positioned separate from and under the one or more second banks.

In some examples, the first portion of non-volatile memory includes a first die and the second portion of the volatile memory includes a second die. In some examples, the first die is coupled with the second die through one or more vias.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

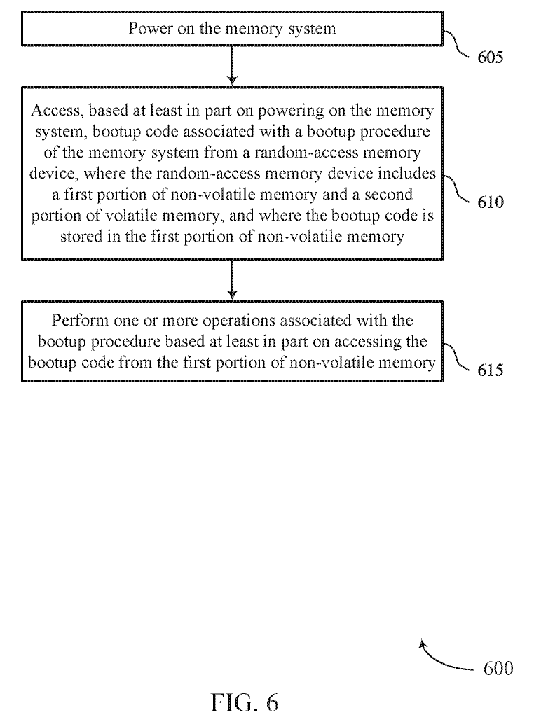

FIG. 6 shows a flowchart illustrating a method 600 that supports a ROM bank for storing bootup code in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include powering on the memory system. In some examples, aspects of the operations of 605 may be performed by a power component 525 as described with reference to FIG. 5.

At 610, the method may include accessing, based at least in part on powering on the memory system, bootup code associated with a bootup procedure of the memory system from a random-access memory device, where the random-access memory device includes a first portion of non-volatile memory and a second portion of volatile memory, and where the bootup code is stored in the first portion of non-volatile memory. In some examples, aspects of the operations of 610 may be performed by a bootup component 530 as described with reference to FIG. 5.

At 615, the method may include performing one or more operations associated with the bootup procedure based at least in part on accessing the bootup code from the first portion of non-volatile memory. In some examples, aspects of the operations of 615 may be performed by a bootup component 530 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for powering on the memory system; accessing, based at least in part on powering on the memory system, bootup code associated with a bootup procedure of the memory system from a random-access memory device, where the random-access memory device includes a first portion of non-volatile memory and a second portion of volatile memory, and where the bootup code is stored in the first portion of non-volatile memory; and performing one or more operations associated with the bootup procedure based at least in part on accessing the bootup code from the first portion of non-volatile memory.

Aspect 2: The method, apparatus, or non-transitory computer-readable medium of aspect 1, further including operations, features, circuitry, logic, means, or instructions, or any combination thereof for applying a permanent memory bit status to a set of transistors of the random-access memory device in accordance with a lithography mask based programming procedure or a laser lithography programming based procedure, where the permanent memory bit status forms the first portion of non-volatile memory in the random-access memory device, and where the bootup code is stored in the first portion of non-volatile memory according to applying the lithography mask based programming procedure or the laser lithography programming based procedure.

Aspect 3: The method, apparatus, or non-transitory computer-readable medium of any of aspects 1 through 2, further including operations, features, circuitry, logic, means, or instructions, or any combination thereof for writing the bootup code to the first portion of non-volatile memory in response to completion of a programming procedure at the memory system.

Aspect 4: The method, apparatus, or non-transitory computer-readable medium of aspect 3, further including operations, features, circuitry, logic, means, or instructions, or any combination thereof for storing, during the programming procedure associated with the memory system, the bootup code in a serial not-OR (NOR) memory device, where the bootup code is written from the serial NOR memory device to the first portion of non-volatile memory.

Aspect 5: The method, apparatus, or non-transitory computer-readable medium of any of aspects 1 through 4, where performing the one or more operations associated with the bootup procedure includes operations, features, circuitry, logic, means, or instructions, or any combination thereof for downloading, from a web server or any other network attached device based at least in part on the bootup code, program code associated with an operating system of the memory system.

Aspect 6: The method, apparatus, or non-transitory computer-readable medium of any of aspects 1 through 5, where the first portion of the non-volatile memory includes one or more banks of the random-access memory device.

Aspect 7: The method, apparatus, or non-transitory computer-readable medium of any of aspects 1 through 6, where the first portion of non-volatile memory includes a first bank and the second portion of volatile memory includes one or more second banks and the first bank is included in circuitry positioned separate from and under the one or more second banks.

Aspect 8: The method, apparatus, or non-transitory computer-readable medium of any of aspects 1 through 7, where the first portion of non-volatile memory includes a first die and the second portion of the volatile memory includes a second die and the first die is coupled with the second die through one or more vias.

It should be noted that the aspects described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 9: A memory system, including: a random-access memory device including a first portion of non-volatile memory and a second portion of volatile memory; and processing circuitry coupled with the random-access memory device and configured to cause the memory system to: power on the memory system; access, based at least in part on powering on the memory system, bootup code associated with a bootup procedure of the memory system, where the bootup code is stored in the first portion of non-volatile memory; and perform one or more operations associated with the bootup procedure based at least in part on accessing the bootup code from the first portion of non-volatile memory.

Aspect 10: The memory system of aspect 9, where the processing circuitry is configured to cause the memory system to: applying a permanent memory bit status to a set of transistors of the random-access memory device in accordance with a lithography mask based programming procedure or a laser lithography programming based procedure, where the permanent memory bit status forms the first portion of non-volatile memory in the random-access memory device, and where the bootup code is stored in the first portion of non-volatile memory according to applying the lithography mask based programming procedure or the laser lithography programming based procedure.

Aspect 11: The memory system of any of aspects 9 through 10, where the processing circuitry is further configured to cause the memory system to: store the bootup code to the first portion of non-volatile memory in response to completion of a programming procedure at the memory system.

Aspect 12: The memory system of aspect 11, further including: a non-volatile memory device coupled with the processing circuitry, where the processing circuitry is further configured to cause the memory system to: store the bootup code to the non-volatile memory device during the programming procedure associated with the memory system, the non-volatile memory device including a serial not-OR (NOR) memory device, where the bootup code is transferred from the serial NOR memory device to the first portion of non-volatile memory of the random access memory device.

Aspect 13: The memory system of any of aspects 9 through 12, where, to perform the one or more operations associated with the bootup procedure, the processing circuitry is configured to cause the memory system to: download, from a server based at least in part on the bootup code, program code associated with an operating system of the memory system.

Aspect 14: The memory system of any of aspects 9 through 13, where the first portion of the non-volatile memory includes one or more banks of the random-access memory device.

Aspect 15: The memory system of any of aspects 9 through 14, where the first portion of non-volatile memory includes a first bank and the second portion of volatile memory includes one or more second banks, and the first bank is included in circuitry positioned separate from and under the one or more second banks.

Aspect 16: The memory system of any of aspects 9 through 15, where the first portion of non-volatile memory includes a first die and the second portion of the volatile memory includes a second die, and the first die is coupled with the second die through one or more vias.

Aspect 17: The memory system of any of aspects 9 through 16, where the bootup code is stored at a first address associated with a starting index of the first portion of the non-volatile memory, accessing the bootup code includes reading the first address associated with the starting index.

Aspect 18: The memory system of any of aspects 9 through 17, where the first portion of non-volatile memory includes a first portion of a first bank of the random-access memory device and the second portion of the volatile memory includes a second portion of the first bank and one or more second banks of the random-access memory device.

Aspect 19: The memory system of aspect 18, where the first portion of the first bank corresponds to a first subset of rows of the first bank, a first subset of columns of the first bank, or both, and the second portion of the first bank including the volatile memory corresponds to a second subset of rows of the first bank, a second subset of columns of the first bank, or both.

An apparatus is described. The following provides an overview of aspects of the apparatus as described herein:

Aspect 20: A system, including: a random-access memory device including a first portion of non-volatile memory and a second portion of volatile memory; a non-volatile memory device; and processing circuitry coupled with the random-access memory device and the non-volatile memory device, the processing circuitry configured to: store, to the first portion of non-volatile memory, bootup code associated with a bootup procedure of the system; and access, in response to powering on the system, the bootup code from the first portion of non-volatile memory.

An apparatus is described. The following provides an overview of aspects of the apparatus as described herein:

Aspect 21: A memory system, comprising: one or more random access devices each including a dynamic random access (DRAM) bank and a random access read only (ROM) bank; and processing circuitry coupled with the one or more random access devices, the processing circuitry configured to cause the memory system to: power on the one or more random access devices; execute a device initialization procedure based at least in part on powering on the one or more random access devices; access a portion of program code that is stored within the ROM banks of the one or more random access devices based at least in part on execution of the device initialization procedure; and execute a first level of a system boot procedure using the portion of the program code.

Aspect 22: The memory system of aspect 21, wherein the processing circuitry is configured to cause the memory system to: download, based at least in part on executing the first level of the system boot procedure, an operating system, software for an application, or both from a web server; and store the operating system and the software in the DRAM banks of the one or more random access devices.

Aspect 23: The memory system of any of aspects 21 through 22, wherein access of the ROM banks of the one or more random access devices is according to a first set of frequency point conditions, a first subset of a set of DRAM commands, or both, and wherein access of the DRAM banks of the one or more random access devices is according to a second set of frequency point conditions, a second subset of the set of DRAM commands, or both.

Aspect 24: The memory system of any of aspects 21 through 23, further comprising a memory interface, wherein access to the DRAM banks and the ROM banks of the one or more random access devices is via the memory interface.

Aspect 25: The memory system of any of aspects 21 through 24, wherein the one or more random access devices comprise a plurality of DRAM transistor-type banks, wherein a portion of the plurality of DRAM transistor-type banks are replaced by one or more ROM transistor-type banks to form the ROM banks, and wherein the ROM transistor-type banks are associated with a first transistor type that is electrically programmable or a second transistor type that is mask programmable, or both.

Aspect 26: The memory system of aspect 25, wherein one or more DRAM transistor-type banks and the one or more ROM transistor-type banks are located on a same die of the one or more random access devices, and wherein the one or more ROM transistor-type banks are mask programmed based at least in part on one or more production processes associated with the one or more random access devices.

Aspect 27: The memory system of any of aspects 25 through 26, wherein the one or more ROM transistor-type banks are electrically programmed based at least in part on a post-production process or based at least in part on signaling from a host system.

Aspect 28: The memory system of any of aspects 25 through 27, wherein one or more of the plurality of DRAM transistor-type banks are located on a first die of the one or more random access devices, wherein the one or more ROM transistor-type banks are located on a second die of the one or more random access devices, and wherein the first die and the second die are coupled by one or more vias.

Aspect 29: The memory system of any of aspects 25 through 28, wherein one or more of the plurality of DRAM transistor-type banks are located on a first die of the one or more random access devices, wherein the one or more ROM transistor-type banks are located on a second die of the one or more random access devices, and wherein the first die and the second die are coupled by two or more interconnected chiplets.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable ROM (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more random access devices each including a dynamic random access (DRAM) bank and a random access read only (ROM) bank; and
processing circuitry coupled with the one or more random access devices, the processing circuitry configured to cause the memory system to:
power on the one or more random access devices;
execute a device initialization procedure based at least in part on powering on the one or more random access devices;
access a portion of program code that is stored within the ROM banks of the one or more random access devices based at least in part on execution of the device initialization procedure; and
execute a first level of a system boot procedure using the portion of the program code.

2. The memory system of claim 1, wherein the processing circuitry is configured to cause the memory system to:
download, based at least in part on executing the first level of the system boot procedure, an operating system, software for an application, or both from a web server or any other network attached device; and
store the operating system and the software in the DRAM banks of the one or more random access devices.

3. The memory system of claim 1, wherein access of the ROM banks of the one or more random access devices is according to a first set of frequency point conditions, a first subset of a set of DRAM commands, or both, and wherein access of the DRAM banks of the one or more random access devices is according to a second set of frequency point conditions, a second subset of the set of DRAM commands, or both.

4. The memory system of claim 1, further comprising a memory interface, wherein access to the DRAM banks and the ROM banks of the one or more random access devices is via the memory interface.

5. The memory system of claim 1, wherein the one or more random access devices comprise a plurality of DRAM transistor-type banks, wherein a portion of the plurality of DRAM transistor-type banks are replaced by one or more ROM transistor-type banks to form the ROM banks, and wherein the one or more ROM transistor-type banks are associated with a first transistor type that is electrically programmable or a second transistor type that is mask programmable, or both.

6. The memory system of claim 5, wherein one or more DRAM transistor-type banks and the one or more ROM transistor-type banks are located on a same die of the one or more random access devices, and wherein the one or more ROM transistor-type banks are mask programmed based at least in part on one or more production processes associated with the one or more random access devices.

7. The memory system of claim 5, wherein the one or more ROM transistor-type banks are electrically programmed based at least in part on a post-production process or based at least in part on signaling from a host system.

8. The memory system of claim 5, wherein one or more of the plurality of DRAM transistor-type banks are located on a first die of the one or more random access devices, wherein the one or more ROM transistor-type banks are located on a second die of the one or more random access devices, and wherein the first die and the second die are coupled by one or more vias.

9. The memory system of claim 5, wherein one or more of the plurality of DRAM transistor-type banks are located on a first die of the one or more random access devices, wherein the one or more ROM transistor-type banks are located on a second die of the one or more random access devices, and wherein the first die and the second die are coupled by two or more interconnected chiplets.

10. A memory system, comprising:
a random-access memory device comprising a first portion of non-volatile memory and a second portion of volatile memory; and
processing circuitry coupled with the random-access memory device and configured to cause the memory system to:
power on the memory system;
access, based at least in part on powering on the memory system, bootup code associated with a bootup procedure of the memory system, wherein the bootup code is stored in the first portion of non-volatile memory; and
perform one or more operations associated with the bootup procedure based at least in part on accessing the bootup code from the first portion of non-volatile memory.

11. The memory system of claim 10, wherein the processing circuitry is configured to cause the memory system to:
apply a permanent memory bit status to a set of transistors of the random-access memory device in accordance with a lithography mask based programming procedure or a laser lithography programming based procedure, where the permanent memory bit status forms the first portion of non-volatile memory in the random-access memory device, and where the bootup code is stored in the first portion of non-volatile memory according to applying the lithography mask based programming procedure or the laser lithography programming based procedure.

12. The memory system of claim 10, wherein the processing circuitry is further configured to cause the memory system to:
store the bootup code to the first portion of non-volatile memory in response to completion of a programming procedure at the memory system.

13. The memory system of claim 12, further comprising:
a non-volatile memory device coupled with the processing circuitry, wherein the processing circuitry is further configured to cause the memory system to:
store the bootup code to the non-volatile memory device during the programming procedure associated with the memory system, the non-volatile memory device comprising a serial not-OR (NOR) memory device, wherein the bootup code is transferred from the serial NOR memory device to the first portion of non-volatile memory of the random-access memory device.

14. The memory system of claim 10, wherein, to perform the one or more operations associated with the bootup procedure, the processing circuitry is configured to cause the memory system to:
download, from a server based at least in part on the bootup code, program code associated with an operating system of the memory system.

15. The memory system of claim 10, wherein the first portion of the non-volatile memory comprises one or more banks of the random-access memory device.

16. The memory system of claim 10, wherein the first portion of non-volatile memory comprises a first bank and the second portion of volatile memory comprises one or more second banks, and wherein the first bank is included in circuitry positioned separate from and under the one or more second banks.

17. The memory system of claim 10, wherein the first portion of non-volatile memory comprises a first die and the second portion of the volatile memory comprises a second die, and wherein the first die is coupled with the second die through one or more vias.

18. The memory system of claim 10, wherein the bootup code is stored at a first address associated with a starting index of the first portion of the non-volatile memory, wherein accessing the bootup code comprises reading the first address associated with the starting index.

19. The memory system of claim 10, wherein the first portion of non-volatile memory comprises a first portion of a first bank of the random-access memory device and the second portion of the volatile memory comprises a second portion of the first bank and one or more second banks of the random-access memory device.

20. A method for operating a memory system, the method comprising:
powering on the memory system;
accessing, based at least in part on powering on the memory system, bootup code associated with a bootup procedure of the memory system from a random-access memory device, wherein the random-access memory device comprises a first portion of non-volatile memory and a second portion of volatile memory, and wherein the bootup code is stored in the first portion of non-volatile memory; and
performing one or more operations associated with the bootup procedure based at least in part on accessing the bootup code from the first portion of non-volatile memory.
